(19) United States
(12) Patent Application Publication
(10) Pub. No.: US 2022/0167825 A1
(43) Pub. Date: Jun. 2, 2022

(54) DISHWASHING APPLIANCE HAVING A WIRELESSLY POWERED LIGHT ASSEMBLY

(71) Applicant: Haier US Appliance Solutions, Inc., Wilmington, DE (US)

(72) Inventor: Matthew David Mersch, Louisville, KY (US)

(21) Appl. No.: 17/108,619

(22) Filed: Dec. 1, 2020

(51) Int. Cl. A47L 15/42; H02J 50/80; F21V 33/00; H02J 50/10; F21V 31/00

(52) U.S. Cl. CPC A47L 15/4293; H02J 50/80; F21V 33/0044; A47L 2401/34; F21V 31/005; A47L 15/4257; H02J 50/10

(57) ABSTRACT

A dishwashing appliance may include a cabinet, a tub, a removable light assembly, and a wireless power transmitter. The tub may define a wash chamber within the cabinet. A removable light assembly may be selectively attached to the tub. The removable light assembly may include a support body, a light source, an onboard controller, and a wireless power receiver. The light source may be mounted on the support body. The onboard controller may be in electrical communication with the light source. The wireless power receiver may be mounted to the support body in electrical communication with the light source and the onboard controller. The wireless power transmitter may be spaced apart from the support body in operable communication with the wireless power receiver to transmit an electromagnetic field thereto.

### FIELD OF THE INVENTION

The present subject matter relates generally to dishwashing appliances, and more particularly to light assemblies for dishwashing appliances.

### BACKGROUND OF THE INVENTION

Dishwashing appliances generally include a tub defining a wash chamber or compartment wherein one or more rack assemblies, into which various articles may be loaded for cleaning, are positioned. Each rack may include features such as, for example, tines that hold and orient the articles to receive sprays of wash and rinse fluids during the cleaning process. The articles to be cleaned may include a variety of dishes, cooking utensils, silverware, and other items.

One of the issues that exists with many conventional dishwashing appliances is the difficulty for user to see within the wash chamber (e.g., when loading or unloading articles). To address this issue, some appliances have attempted to mount one or more lights onto the tub. Wires routed and through the tub may electrically connect the lights to a power source outside of the wash chamber. Unfortunately, though, this approach generally introduces potential leak points from which water may escape the wash chamber. Over time, such leak points may cause damage to the lights or dishwashing appliance, generally. Moreover, after a particular appliance unit user may be unable to vary the configuration or operation of the lights. If a user has purchased a unit or model without a light (or with a light that is ultimately unsatisfactory), there is typically nothing that a user can do short of buying a new dishwashing appliance.

As a result, it would be useful to provide an appliance or light assembly with an improved or variable light arrangement. In particular, it would be advantageous if such an appliance or assembly could be provided without introducing additional potential leak points such that might be created from additional electrical or mechanical connections through the tub.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a dishwashing appliance is provided. The dishwashing appliance may include a cabinet, a tub, a removable light assembly, and a wireless power transmitter. The tub may define a wash chamber within the cabinet. A removable light assembly may be selectively attached to the tub. The removable light assembly may include a support body, a light source, an onboard controller, and a wireless power receiver. The light source may be mounted on the support body. The onboard controller may be in electrical communication with the light source. The wireless power receiver may be mounted to the support body in electrical communication with the light source and the onboard controller. The wireless power transmitter may be spaced apart from the support body in operable communication with the wireless power receiver to transmit an electromagnetic field thereto.

In another exemplary aspect of the present disclosure, a dishwashing appliance is provided. The dishwashing appliance may include a cabinet, a tub, a first removable light assembly, a second removable light assembly, and a wireless power transmitter. The tub may define a wash chamber within the cabinet. The tub may include an inner liner defining a wash chamber within the cabinet. The first removable light assembly may be is electrically sealed and selectively attached to the tub in fluid isolation from the inner linear. The first removable light assembly may include a support body, a light source mounted on the support body, an onboard controller in electrical communication with the light source of the first removable light assembly, and a wireless power receiver mounted to the support body in electrical communication with the light source and the onboard controller of the first removable light assembly. The second removable light assembly may be is electrically sealed and selectively attached to the tub in fluid isolation from the inner linear apart from the first removable light assembly. The second removable light assembly may include a support body, a light source mounted on the support body, an onboard controller in electrical communication with the light source of the second removable light assembly, and a wireless power receiver mounted to the support body in electrical communication with the light source and the onboard controller of the second removable light assembly. The wireless power transmitter may be spaced apart from the first and second removable light assemblies in operable communication with the wireless power receivers to transmit an electromagnetic field thereto.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front elevation view of a dishwashing appliance according to exemplary embodiments of the present disclosure.

FIG. 2 provides a side, cross-sectional view of the exemplary dishwashing appliance of FIG. 1.

FIG. 3 provides a magnified, front, cross-sectional view of a portion of the dishwashing appliance of FIG. 1.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows.

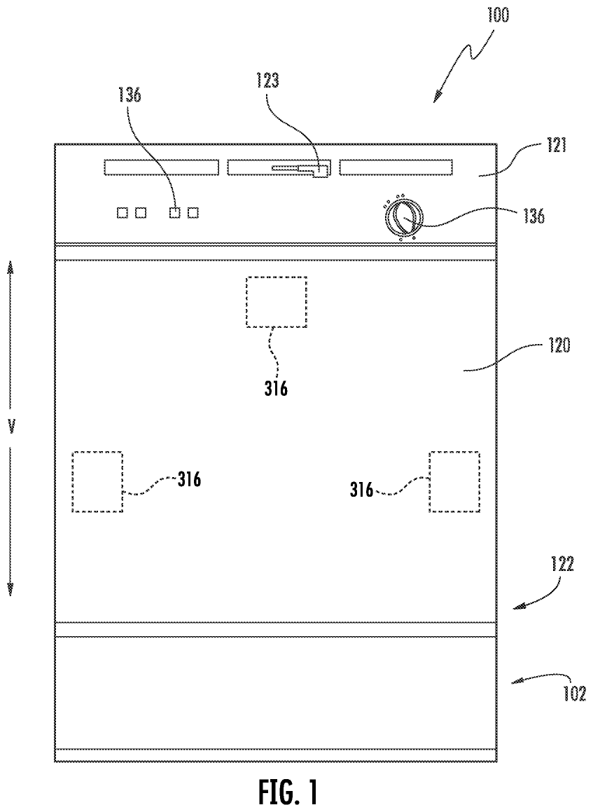

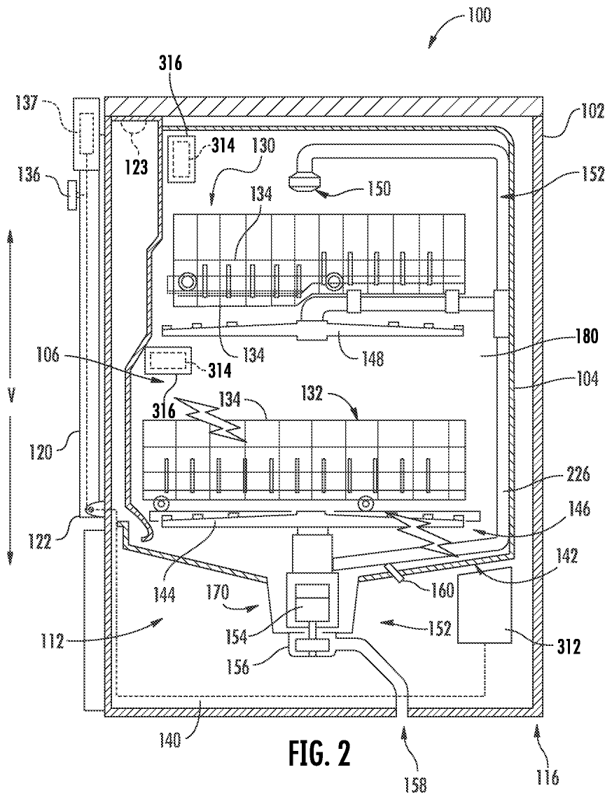

FIGS. 1 and 2 depict a dishwashing appliance 100 according to an exemplary embodiment of the present disclosure. As shown in FIG. 1, dishwashing appliance 100 includes a cabinet 102. Cabinet 102 has a tub 104 therein that defines a wash compartment 106 (e.g., at an inner liner 180 of tub 104). The tub 104 also defines a front opening (not shown). Dishwashing appliance 100 includes a door 120 hinged at a bottom 122 of door 120 for movement between a normally closed, vertical position (shown in FIGS. 1 and 2), wherein wash compartment 106 is sealed shut for washing operation, and a horizontal, open position for loading and unloading of articles from dishwashing appliance 100. In some embodiments, a latch 123 is used to lock and unlock door 120 for access to wash compartment 106. Tub 104 also includes a sump 170 positioned adjacent a bottom portion 112 of tub 104 and configured for receipt of a liquid wash fluid (e.g., water, detergent, wash fluid, or any other suitable fluid) during operation of dishwashing appliance 100.

In certain embodiments, a spout 160 is positioned adjacent sump 170 of dishwashing appliance 100. Spout 160 is configured for directing liquid into sump 170. Spout 160 may receive liquid from, for example, a water supply (not shown) or any other suitable source. In alternative embodiments, spout 160 may be positioned at any suitable location within dishwashing appliance 100 (e.g., such that spout 160 directs liquid into tub 104). Spout 160 may include a valve (not shown) such that liquid may be selectively directed into tub 104. Thus, for example, during the cycles described below, spout 160 may selectively direct water or wash fluid into sump 170 as required by the current cycle of dishwashing appliance 100.

Rack assemblies 130 and 132 may be slidably mounted within wash compartment 106. In some embodiments, each of the rack assemblies 130 and 132 is fabricated into lattice structures including a plurality of elongated members 134. Each rack of the rack assemblies 130 and 132 is generally adapted for movement between an extended loading position (not shown) in which the rack is substantially positioned outside the wash compartment 106, and a retracted position (shown in FIGS. 1 and 2) in which the rack is located inside the wash compartment 106. A silverware basket (not shown) may be removably attached to rack assembly 132 for placement of silverware, utensils, and the like, that are otherwise too small to be accommodated by the racks 130 and 132.

In certain embodiments, dishwashing appliance 100 includes a lower spray assembly 144 that is rotatably mounted within a lower region 146 of the wash compartment 106 and above sump 170 so as to rotate in relatively close proximity to rack assembly 132. Optionally, a mid-level spray assembly 148 is located in an upper region of the wash compartment 106 and may be located in close proximity to upper rack 130. Additionally or alternatively, an upper spray assembly 150 may be located above the upper rack 130.

In exemplary embodiments, lower and mid-level spray assemblies 144 and 148 and the upper spray assembly 150 are fed by a fluid circulation assembly 152 for circulating water and dishwasher fluid in the tub 104. Fluid circulation assembly 152 includes one or more fluid pumps (e.g., a circulation pump 154 or a cross-flow/drain pump 156). Some embodiments include circulation pump 154 positioned at least partially within sump 170 and drain pump 156 positioned below circulation pump 154 in fluid communication with sump 170. Additionally, drain pump 156 may be configured for urging the flow of wash fluid from sump 170 to a drain 158 when activated. By contrast, circulation pump 154 may be configured for supplying a flow of wash fluid from sump 170 to spray assemblies 144, 148 and 150 by way of one or more circulation conduits 226 when activated. Moreover, a filter assembly may be also positioned at least partially in sump 170 for filtering food particles or other debris, referred to herein generally as soils, from wash fluid prior to such wash fluid flowing to circulation pump 154.

Spray assemblies 144, 148, and 150 include an arrangement of discharge nozzles or orifices for directing wash fluid onto dishes or other articles located in rack assemblies 130 and 132. The arrangement of the discharge nozzles in spray assemblies 144 and 148 provides a rotational force by virtue of wash fluid flowing through the discharge ports. The resultant rotation of the spray assemblies 144 and 148 provides coverage of dishes and other dishwasher contents with a spray of wash fluid.

Dishwashing appliance 100 is further equipped with a controller 137 (i.e., appliance controller) to regulate operation of the dishwashing appliance 100. Controller 137 may include a memory (e.g., non-transitive media) and microprocessor, such as a general or special purpose microprocessor operable to execute programming instructions or micro-control code associated with a washing operation. The memory may represent random access memory such as DRAM, or read only memory such as ROM or FLASH. In some embodiments, the processor executes programming instructions stored in memory. The memory may be a separate component from the processor or may be included onboard within the processor. Alternatively, controller 137 may be constructed without using a microprocessor (e.g., using a combination of discrete analog or digital logic circuitry, such as switches, amplifiers, integrators, comparators, flip-flops, AND gates, and the like) to perform control functionality instead of relying upon software.

Controller 137 may be positioned in a variety of locations throughout dishwashing appliance 100. In the illustrated embodiment, controller 137 may be located within a control panel area 121 of door 120 as shown. In such an embodiment, input/output (“I/O”) signals may be routed between controller 137 and various operational components of dishwashing appliance 100 along wiring harnesses that may be routed through the bottom 122 of door 120. Typically, controller 137 includes a user interface panel 136 through which a user may select various operational features and modes and monitor progress of the dishwashing appliance 100. In some embodiments, user interface 136 may represent a general purpose I/O (“GPIO”) device or functional block. In certain embodiments, user interface 136 may include input components, such as one or more of a variety of electrical, mechanical or electro-mechanical input devices including rotary dials, push buttons, and touch pads. User interface 136 may include a display component, such as a digital or analog display device designed to provide operational feedback to a user. User interface 136 may be in communication (e.g., electrical or wired communication) with controller 137 via one or more signal lines or shared communication busses.

It should be appreciated that the subject matter disclosed herein is not limited to any particular style, model or configuration of dishwashing appliance, and that the embodiment depicted in the figures is for illustrative purposes only. For example, instead of the racks 130 and 132 depicted in FIG. 1, dishwashing appliance 100 may be of a known configuration that utilizes drawers that pull out from the cabinet and are accessible from the top for loading and unloading of articles.

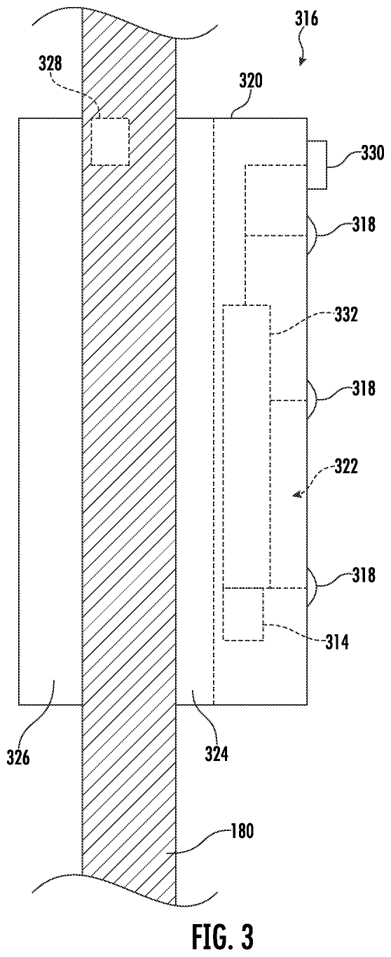

In some embodiments, a wireless power transmitter 312 is provided to supply power to one or more electric devices within dishwashing appliance 100. In particular, wireless power transmitter 312 may be mounted on or within cabinet 102 operable communication (e.g., wireless or contact-free communication) with the wireless power receiver 314 to transmit an electromagnetic field thereto, which may then power one or removable light assemblies 316 each having one or more corresponding light sources 318 (FIG. 3). For instance, wireless power transmitter 312 may transmit an electromagnetic field to multiple removable light assemblies 316 simultaneously.

As shown, wireless power transmitter 312 and wireless power receiver 314 may be physically spaced apart at discrete portions of dishwashing appliance 100. When assembled, wireless power transmitter 312 and wireless power receiver 314 may thus be wirelessly coupled without ever coming into direct or electrical contact. In turn, an air gap may be maintained between the two. In some embodiments, wireless power receiver 314 may be disposed within the wash chamber 106 (e.g., on an inner liner 180 of tub 104 or door 120) while wireless power transmitter 312 is mounted or disposed outside of wash chamber 106. For instance, the inner liner 180 of tub 104 may be electrically sealed such that no electrical wires or busses pass through tub 104. Advantageously, a potential failure or leak point may be avoided while still permitting power to be supplied to an electrical component connected to wireless power receiver 314.

Referring now especially to FIGS. 2 and 3, each removable light assembly 316 may include a support body 320 on which a corresponding wireless power receiver 314 and one or more light sources 318 are mounted. Generally, support body 320 may be provided as any suitable casing or structure defining an internal volume 322. When assembled, support body 320 may be permitted to selectively move relative to cabinet 102 and door 120. For instance, a user may be able to pull support body 320 from a mounted position a location on inner liner 180 or door 120. In some such embodiments, no electrical or fluid communication is established between tub 104 and support body 320. Support body 320, and removable light assembly 316 generally, may be electrically sealed. Thus, no electrical connection to a component outside of internal volume 322 may be established with any of the components within internal volume 322 (e.g., through support body 320). Optionally, removable light assembly 316 may be an electrically isolated assembly. In particular, removable light assembly 316 may be electrically isolated such that no electrical power storage (e.g., electrical battery or ultracapacitor) is provided thereon. Thus, in the absence of wireless communication with wireless power transmitter 312, removable light assembly 316 may be free of a current or voltage therethrough, advantageously preventing unintended operation (e.g., when door 120 is in a closed position).

In spite of being electrically sealed, support body 320 may selectively attach to the tub 104 (e.g., directly at inner liner 180 or indirectly via a chamber-facing surface of door 120), such as through a complementary interlocking fastener set (e.g., pin-recess, mated clips, hooks, etc.) formed between support body 320 and tub 104 or door 120. In some embodiments, removable light assembly 316 includes a magnetic mounting element 324 (e.g., permanent magnet or ferromagnetic material). Specifically, magnetic mounting element 324 may be attached to support body 320 and fixed relative thereto (e.g., via one or more mechanical fasteners, adhesives, etc.). Thus, magnetic mounting element 324 may move with support body 320 relative to cabinet 102. For instance, magnetic mounting element 324 may be fixed within internal volume 322 or to an outer surface of support body 320. Optionally, magnetic mounting element 324 may be disposed on support body 320 opposite of light source 318. In some embodiments, tub 104 includes a complementary magnetic element 326 (e.g., permanent magnet or ferromagnetic material) fixed thereto. For instance, the complementary magnetic element 326 may be fixed to the inner liner 180 of tub 104 outside of wash chamber 106. In such embodiments, complementary magnetic element 326 may define a location at which magnetic mounting element 324 (and, thus, support body 320) may be attached. In additional or alternative embodiments, inner liner 180 of tub 104 may be formed from a ferromagnetic material, such as stainless steel, to permit removable light assembly 316 to be attached at virtually any uncovered portion of inner liner 180.

In certain embodiments, a position sensor 328 is mounted to the cabinet 102 (e.g., on or within inner liner 180) to detect the presence of a removable light assembly 316 (e.g., when removable light assembly 316 is attached to tub 104 or in response to the same). Such a position sensor 328 may include or be provided as a reed switch (e.g., mechanical or magnetic reed switch), Hall effect sensor, MEMS sensor, or other suitable sensor for detecting when removable light assembly 316 is attached to tub 104 (e.g., at a predefined location). In some such embodiments, controller 137 may be in operable communication (e.g., electrical or wireless communication) with position sensor 328 to receive one or more signals therefrom. Moreover, controller 137 may be configured to selectively permit/restrict transmission of the electromagnetic field from wireless power transmitter 312 based on the signal(s) received from position sensor 328. For instance, in response to a signal (or lack thereof) from position sensor 328 indicating detection of the removable light assembly 316, controller 137 may activate wireless power transmitter 312 or otherwise permit transmission of the electromagnetic field. By contrast, in response to a signal (or lack thereof) from position sensor 328 indicating removable light assembly 316 has not been detected (i.e., is not attached to cabinet 102), controller 137 may halt or otherwise prevent transmission of the electromagnetic field. Advantageously, power consumption may be limited when no removable light assembly 316 is present or available for use within wash chamber 106.

Separate from or addition to position sensor 328, controller 137 may be in operable communication with latch assembly 123 (or a sensor corresponding thereto). In some such embodiments, controller 137 is configured to selectively permit/restrict transmission of the electromagnetic field from wireless power transmitter 312 based on one or more signal(s) received from latch assembly 123. For instance, in response to a signal (or lack thereof) from latch assembly 123 indicating that door 120 is not engaged with latch assembly 123 (i.e., is not in a closed position) the removable light assembly 316, controller 137 may activate wireless power transmitter 312 or otherwise permit transmission of the electromagnetic field. By contrast, in response to a signal (or lack thereof) from latch assembly 123 indicating the door 120 is in the closed position (i.e., is fully closed), controller 137 may halt or otherwise prevent transmission of the electromagnetic field and, thus, prevent light source 318 from emitting any light. Advantageously, power consumption may be limited when door 120 is closed and light from removable light assembly 316 within wash chamber 106 would not be visible.

Generally, light source 318 may be provided as any suitable electrically-driven light (e.g., bulb, diode, etc.) to illuminate wash chamber 106. For instance, light source 318 may include a light emitting diode (LED) configured to emit a single visible color or multiple predetermined colors. In optional embodiments, an onboard controller 332 may be provided within internal volume 322 in electrical communication with the corresponding light source(s) 318 and wireless power receiver 314.

Onboard controller 332 may include a memory (e.g., non-transitive media) and microprocessor, such as a general or special purpose microprocessor operable to execute programming instructions or micro-control code associated with a lighting operation. The memory may represent random access memory such as DRAM, or read only memory such as ROM or FLASH. In some embodiments, the processor executes programming instructions stored in memory. The memory may be a separate component from the processor or may be included onboard within the processor. Alternatively, onboard controller 332 may be constructed without using a microprocessor (e.g., using a combination of discrete analog or digital logic circuitry, such as switches, amplifiers, integrators, comparators, flip-flops, AND gates, and the like) to perform control functionality instead of relying upon software.

Generally, wireless power transmitter 312 and wireless power receiver 314 may be configured to exchange an electromagnetic field that generates an electrical current. For instance, wireless power transmitter 312 may transmit an electromagnetic field (e.g., as initiated by controller 137) that is received at wireless power receiver 314. At wireless power receiver 314, an electrical current or voltage may be generated and, subsequently, transmitted to onboard controller 332 or light source(s) 318 (e.g., through an on-board rectifying circuit or activation circuit). For instance, the electromagnetic field may induce an electrical current at wireless power receiver 314 that can be received by onboard controller 332 or light source(s) 318. During operations, onboard controller 332 may be powered by wireless power receiver 314. When assembled, onboard controller 332 may thus selectively activate or direct light emissions from the light source(s) 318 following reception of the electromagnetic field.

As would be understood, the wireless power transmitter 312 and wireless power receiver 314 may be a matched pair of resonant induction coils. Nonetheless, it is understood that any other suitable wireless power transmission method (e.g., inductive coupling, capacitive coupling, etc.) may be used.

In optional embodiments, a motion sensor 330 is provided on one or more removable light assembly 316. Specifically, motion sensor 330 may be mounted on the support body 320 in electrical communication with the onboard controller 332. When assembled, motion sensor 330 may be configured to detect motion relative to removable light sensor. Thus, in response to such a detection, motion sensor 330 may transmit a corresponding signal to onboard controller 332. Generally, motion sensor 330 may be provided as any suitable sensing device for detecting relative motion (e.g., of door 120, a rack assembly 130 or 132, a user within wash chamber 106, etc.). For instance, motion sensor 330 may include or an infrared sensor, ultrasonic sensor, accelerometer, gyroscope, etc. During use, motion sensor 330 may thus detect when door 120 is open or a user has begun to interact with elements/articles within wash chamber 106. In response to detecting motion relative to the removable light assembly 316, onboard controller 332 may activate one or more of the connected light sources 318 (e.g., for a predetermined period of time) to illuminate wash chamber 106.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dishwashing appliance defining a vertical direction, the dishwashing appliance comprising:
a cabinet;
a tub defining a wash chamber within the cabinet;
a removable light assembly selectively attached to the tub, the removable light assembly comprising
a support body,
a light source mounted on the support body,
an onboard controller in electrical communication with the light source, and
a wireless power receiver mounted to the support body in electrical communication with the light source and the onboard controller; and
a wireless power transmitter spaced apart from the support body in operable communication with the wireless power receiver to transmit an electromagnetic field thereto.

2. The dishwashing appliance of claim 1, wherein the removable light assembly is electrically sealed.

3. The dishwashing appliance of claim 1, wherein the support body is disposed on an inner surface of the tub.

4. The dishwashing appliance of claim 1, further comprising a door rotatably mounted to the cabinet to restrict access to the wash chamber, wherein the support body is disposed a surface of the door.

5. The dishwashing appliance of claim 1, wherein the removable light assembly further comprises a magnetic mounting element attached to the support body and fixed relative thereto.

6. The dishwashing appliance of claim 1, wherein the removable light assembly further comprises a motion sensor mounted on the support body in electrical communication with the onboard controller to detect motion relative to the removable light assembly, and wherein the onboard controller is configured to activate the light source in response to detecting motion relative to the removable light assembly.

7. The dishwashing appliance of claim 1, further comprising
a position sensor mounted to the cabinet to detect the removable light assembly; and
an appliance controller attached to the cabinet in operable communication with the position sensor and the wireless power transmitter, wherein the appliance controller is configured to permit transmission of the electromagnetic field in response to detecting the removable light assembly at the position sensor.

8. The dishwashing appliance of claim 1, further comprising
a door rotatably mounted to the cabinet to restrict access to the wash chamber; and
an appliance controller attached to the cabinet in operable communication with the wireless power transmitter, the appliance controller being configured to detect the door out of a closed position and permit transmission of the electromagnetic field in response to detecting the door of the closed position.

9. The dishwashing appliance of claim 8, wherein the removable light assembly further comprises a motion sensor mounted on the support body in electrical communication with the onboard controller to detect motion relative to the removable light assembly, and wherein the onboard controller is configured to activate the light source in response to detecting motion relative to the removable light assembly.

10. The dishwashing appliance of claim 1, wherein the removable light assembly is a first removable light assembly, and wherein the dishwashing appliance further comprises a second removable light assembly selectively attached to the tub apart from the first removable light assembly.

11. A dishwashing appliance defining a vertical direction, the dishwashing appliance comprising:
a cabinet;
a tub comprising an inner liner defining a wash chamber within the cabinet;
a first removable light assembly that is electrically sealed and selectively attached to the tub in fluid isolation from the inner linear, the first removable light assembly comprising
a support body,
a light source mounted on the support body,
an onboard controller in electrical communication with the light source of the first removable light assembly, and
a wireless power receiver mounted to the support body in electrical communication with the light source and the onboard controller of the first removable light assembly;
a second removable light assembly that is electrically sealed and selectively attached to the tub in fluid isolation from the inner linear apart from the first removable light assembly, the second removable light assembly comprising
a support body,
a light source mounted on the support body,
an onboard controller in electrical communication with the light source of the second removable light assembly, and
a wireless power receiver mounted to the support body in electrical communication with the light source and the onboard controller of the second removable light assembly; and
a wireless power transmitter spaced apart from the first and second removable light assemblies in operable communication with the wireless power receivers to transmit an electromagnetic field thereto.

12. The dishwashing appliance of claim 11, wherein the support body of the first removable light assembly is disposed on an inner surface of the tub.

13. The dishwashing appliance of claim 11, further comprising a door rotatably mounted to the cabinet to restrict access to the wash chamber, wherein the support body of the first removable light assembly is disposed a surface of the door.

14. The dishwashing appliance of claim 11, wherein the first removable light assembly further comprises a magnetic mounting element attached to the support body and fixed relative thereto.

15. The dishwashing appliance of claim 11, wherein the first removable light assembly further comprises a motion sensor mounted on the support body of the first removable light assembly in electrical communication with the onboard controller of the first removable light assembly to detect motion relative to the first removable light assembly, and wherein the onboard controller of the first removable light assembly is configured to activate the light source of the first removable light assembly in response to detecting motion relative to the first removable light assembly.

16. The dishwashing appliance of claim 11, further comprising
a position sensor mounted to the cabinet to detect the first removable light assembly; and
an appliance controller attached to the cabinet in operable communication with the position sensor and the wireless power transmitter, wherein the appliance controller is configured to permit transmission of the electromagnetic field in response to detecting the first removable light assembly at the position sensor.

17. The dishwashing appliance of claim 11, further comprising
a door rotatably mounted to the cabinet to restrict access to the wash chamber;
an appliance controller attached to the cabinet in operable communication with the wireless power transmitter, the appliance controller being configured to detect the door out of a closed position and permit transmission of the electromagnetic field in response to detecting the door of the closed position.

18. The dishwashing appliance of claim 17, wherein the first removable light assembly further comprises a motion sensor mounted on the support body of the first removable light assembly in electrical communication with the onboard controller of the first removable light assembly to detect motion relative to the first removable light assembly, and wherein the onboard controller of the first removable light assembly is configured to activate the light source of the first removable light assembly in response to detecting motion relative to the first removable light assembly.
